(19) United States
(12) Patent Application Publication
(10) Pub. No.: US 2012/0170294 A1
(43) Pub. Date: Jul. 5, 2012

(54) Housing for a ballast

(75) Inventor: Lars Kolbe, Glonn (DE)

(73) Assignee: OSRAM AG, Muenchen (DE)

(21) Appl. No.: 13/394,551

(22) PCT Filed: Aug. 19, 2010
(86) PCT No.: PCT/EP2010/062084

§ 371 Date: Mar. 7, 2012

(30) Foreign Application Priority Data
Sep. 8, 2009 (DE) 10 2009 040 573.9

(51) Int. Cl. F21V 23/00; B60Q 1/00

(52) U.S. Cl. 362/459

(57) ABSTRACT

In various embodiments, a housing for a ballast for operating a discharge lamp provided as a light source for a vehicle headlamp includes a housing forming an inner chamber to accommodate electrical components of the ballast, the housing configured such that it has an annular circumferential recess on its exterior, in which is arranged a sealing ring and on which fasteners are provided for the ballast, the fasteners being arranged outside the area on the exterior of the housing enclosed by the annular recess and the sealing ring.

The invention relates to a housing for a ballast for operating a discharge lamp, which is provided as a light source for a vehicle headlamp.

### I. PRIOR ART

A housing of this kind is for example disclosed in the patent application WO 2005/034589 A2. This document describes a housing for a ballast for operating a halogen metal vapor-high-pressure discharge lamp, which is provided as a light source in a vehicle headlamp. The housing includes two halves, which form an inner chamber to accommodate the electrical components of the ballast. The inner chamber is sealed peripherally by means of a circumferential 0-ring between the two halves of the housing.

The housing has the disadvantage that it enables no fixing directly to the vehicle headlamp and no sealing against the vehicle headlamp.

### II. STATEMENT OF THE INVENTION

The object of the invention is to provide a generic housing, which does not have the aforementioned disadvantages. In particular it should be possible to fix the inventive housing directly to the vehicle headlamp and to create a seal against the vehicle headlamp.

This object is achieved by a housing with the features from claim 1. Advantageous developments of the invention are disclosed in the dependent claims.

The inventive housing for a ballast for operating a discharge lamp, which is provided as a light source for a vehicle headlamp, forms an inner chamber to accommodate electrical components of the ballast, and according to the invention has an annular circumferential recess on its exterior, in which is arranged a sealing ring, and further has fixing means, which are arranged outside the area on the exterior of the housing surrounded by the annular recess and the sealing ring.

By means of the sealing ring, which is arranged in an annular circumferential recess on the exterior of the housing, this wall area of the housing can be used, in the manner of a cover, to seal the rear of a vehicle headlamp. The fasteners arranged on the exterior of the housing outside the area of the housing surrounded by the annular recess and the sealing ring allow fixing of the housing or of the ballast directly to the rear of the vehicle headlamps. The length of the electrical connectors used between the ballast and the lamp in the vehicle headlamp is thereby reduced.

The annular circumferential recess is advantageously embodied in conical form. The sealing ring can thereby be introduced into the recess in a force-fitted manner and secured against falling out of the recess during handling of the ballast or of the ballast housing. To this end, the annular circumferential recess is preferably embodied in tapered form in the direction of its base, that is to say it preferably has a V-shaped profile. The force-fitting of the sealing ring can thus be achieved in a simple manner, in that the sealing ring is pressed deep into the recess.

The depth of the annular circumferential recess in the exterior of the housing is advantageously greater than the gauge or thickness of the sealing ring. The upper or outer part of the annular circumferential recess thereby annular groove, which can accommodate a correspondingly annular-shaped stud on the vehicle headlamp, which after mounting of the ballast on the rear of the vehicle headlamp engages in the annular circumferential recess and rests on the sealing ring arranged therein in a press-fitted manner, so that the sealing ring is pressed against the base and the side walls of the annular circumferential recess on the exterior of the housing.

The sealing ring preferably includes silicon, as silicon sealing rings have a sealing effect similarly good to that of, for example, foam rings or rings made of other plastic material, but are easier and cheaper to manufacture. In addition, the temperature range for the use of sealing rings based on silicon matches that required in products for application in the vehicle.

On its exterior, within the area surrounded by the annular recess and the sealing ring, the inventive housing advantageously has electrical connections, for example for connection of the discharge lamp to be operated by the ballast, and/or of the supply voltage. After the assembly of the ballast on the vehicle headlamp the electrical connections are thereby protected against corrosion and damage, and against being contacted.

The inventive housing of the ballast is advantageously embodied in metallic from, in order to guarantee electromagnetic shielding of the components of the ballast arranged in the inner chamber of the housing. The housing preferably includes magnesium or aluminum castings, in order to enable low weight and good resistance to corrosion.

The inventive housing advantageously has ribs for stiffening purposes, in order in particular to protect large-area side walls of the housing and mounting boards which may run adjacent to them against bending stresses.

The inventive housing advantageously forms cooling surfaces, which are thermally coupled to heat-sensitive or heat-generating components of the ballast in the inner chamber of the housing, in order to dissipate the heat to the outside.

### III. DESCRIPTION OF THE PREFERRED EXEMPLARY EMBODIMENT

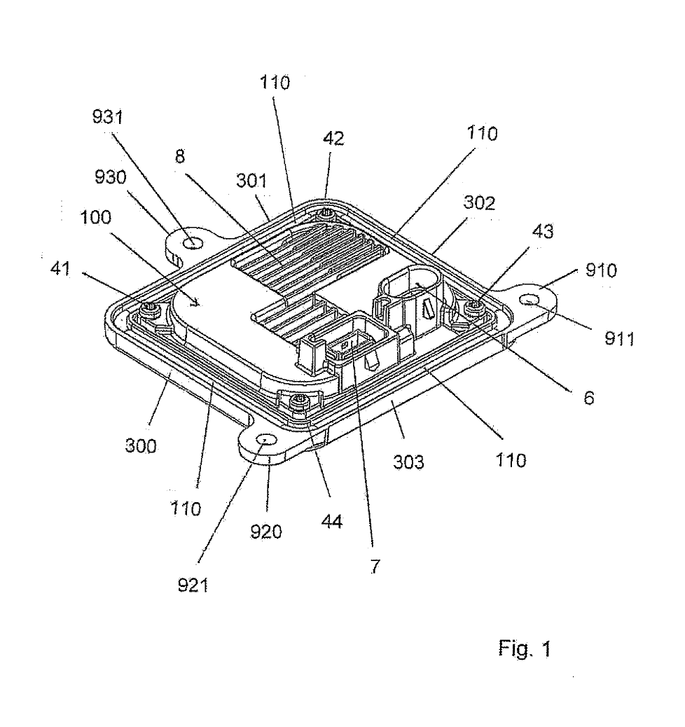

FIG. 1 shows a top view of the front of the housing according to the preferred exemplary embodiment, in three-dimensional form

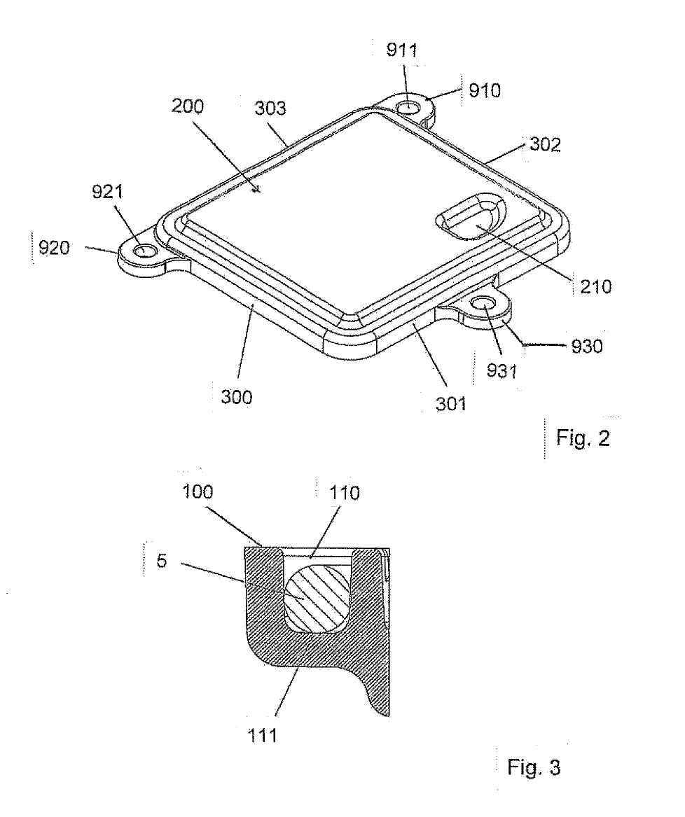

FIG. 2 shows a top view of the rear of the housing depicted in FIG. 1, in three-dimensional form

FIG. 3 shows a cross-section through the annular circumferential recess on the exterior of the housing in the area of the front

FIGS. 1 and 2 show the housing according to the preferred exemplary embodiment of the invention. The housing is essentially square in shape and embodied in very flat, almost plate-like form. It has a large side 200 and four side walls 300, 301, 302, 303. The aforementioned six sides of the housing form a closed inner chamber, in which the components of the ballast for operating a halogen metal vapor-high-pressure discharge lamp, which serves as a light source in a vehicle headlamp, are arranged on a mounting board (not shown). The mounting board runs parallel to the front 100 and rear 200 of the housing. The edges between the side walls 300, 301, 302, 303 are rounded off. The housing includes two magnesium cast parts, which are connected to each other by means of screws 41, 42, 43, 44. The housing has an annular circumferential recess 110 in the exterior of the front 100 parallel to the edge of the front 100. This recess 110 has a V-shaped profile, so that it is tapered in the direction of the base of the recess 111. A sealing ring 5 made of silicon is arranged, in a force-fitted manner, in the recess 100. The silicon ring 5 has a gauge or thickness of 4 mm. The width of the annular circumferential recess is 4.1 mm at its opening. In the direction of its base 111 the recess 110 is embodied so as to be tapered by approx. 2 degrees at its lateral edges.

Arranged on the front 100, within the area of the front 100 surrounded by the annular circumferential recess 110 and the silicon ring 5, are two plugs 6, 7, which serve as electrical connections of the ballast. A first plug 6 serves to connect the voltage supply for the ballast, and the second plug 7 serves to connect the high-pressure discharge lamp (not shown) or as the case may be the high-pressure discharge lamp and its ignition unit. Outside the area of the front 100 surrounded by the recess 110 and the silicon ring, three laterally projecting lugs 910, 920, 930, which are in each case provided with a drilled hole 911, 921, 931, are arranged along the side walls 300, 301, 302 of the housing. Screws are introduced into the drilled holes 911, 921, 931, which are provided for fixing of the ballast or the ballast housing on the rear of the vehicle headlamp. After fixing of the ballast on the rear of the vehicle headlamp, the plugs 6, 7 project into the interior of the vehicle headlamp and an annular stud (not shown) on the rear of the vehicle headlamp engages in the recess 110 and presses the silicon ring 5 against the base 111 of the recess and against the edge of the recess 110. The vehicle headlamp is thereby sealed at the rear by means of the front 100 of the housing, the recess 110 and the silicon ring 5. The ballast or its housing effectively serves as a cover to close off the rear of the vehicle headlamp. After assembly, the front 100 of the housing lies closely against the rear of the vehicle headlamp, so that then only the rear 200 of the housing is visible.

The front 100 of the housing has a multiplicity of stiffening ribs 8, which serve to provide mechanical stabilization of the housing and to enhance its flexural strength and also increase the stability of the front 100 against pressure and bending, so that the mounting board lying thereunder is protected against mechanical stress.

In the rear 200 of the housing is arranged an indentation 210 oriented towards the inner chamber of the housing, which is thermally coupled to heat-sensitive components of the ballast and whose surface serves as a cooling surface.

1. A housing for a ballast for operating a discharge lamp provided as a light source for a vehicle headlamp, comprising:
a housing forming an inner chamber to accommodate electrical components of the ballast, the housing configured such that it has an annular circumferential recess on its exterior in which is arranged a sealing ring, and on which fasteners are provided for the ballast, the fasteners being arranged outside the area on the exterior of the housing enclosed by the annular recess and the sealing ring.

2. The housing as claimed in claim 1, wherein the annular circumferential recess is embodied in conical form.

3. The housing as claimed in claim 1, wherein the annular circumferential recess is embodied in tapered form in the direction of its base.

4. The housing as claimed in claim 1, wherein the depth of the recess in the exterior of the housing is greater than the thickness or gauge of the sealing ring.

5. The housing as claimed in claim 1, wherein the sealing ring comprises silicon.

6. The housing as claimed in claim 1, wherein electrical connections are arranged on the exterior of the housing, within the area surrounded by the annular recess and the sealing ring.

7. The housing as claimed in claim 1, wherein the housing is metallic.

8. The housing as claimed in claim 7, wherein the housing comprises magnesium cast material or aluminum castings.

9. The housing as claimed in claim 1, wherein the housing has ribs for stiffening purposes.

10. The housing as claimed in claim 1, wherein the housing forms cooling surfaces.

11. The housing as claimed in claim 1, further including a ballast for operating a discharge lamp.
